(19) United States
(12) Patent Application Publication
(10) Pub. No.: US 2025/0298600 A1
(43) Pub. Date: Sep. 25, 2025

(54) NON-DISRUPTIVE NIC FIRMWARE UPGRADE IN MULTI-HOST ENVIRONMENT

(71) Applicant: Dell Products L.P., Hopkinton, MA (US)

(72) Inventors: Qin Wang, Northborough, MA (US); Jitender Sawal, Watertown, MA (US); Jerome Cartmell, Millis, MA (US); Jonathan Krasner, Coventry, RI (US); Julie Zhivich, Westborough, MA (US)

(73) Assignee: Dell Products L.P., Hopkinton, MA (US)

(21) Appl. No.: 18/610,337

(22) Filed: Mar. 20, 2024

(51) Int. Cl. G06F 8/65; H04L 49/00

(52) U.S. Cl. CPC G06F 8/65; H04L 49/30

(57) ABSTRACT

In a multi-host storage system, failover is invoked to update NIC firmware. Failover causes first and second hosts with first and second NICs to use the first NIC and cease using the second NIC. Bus links enable the second host to use the first NIC. The second NIC firmware is updated after associated transport resources and drivers are deleted and memory resources freed. New drivers are installed, and transport resources rebuilt. Multi-host virtual ports are re-synchronized and the functionality of the updated NIC is enabled. Failover allows the second host to continue processing IOs while the second NIC is being updated.

### TECHNICAL FIELD

The subject matter of this disclosure is generally related to multi-host storage systems.

### BACKGROUND

Organizational data storage systems are used to maintain storage objects that are accessed by instances of host applications running on clusters of host servers. Examples of host applications include software for email, e-business, accounting, inventory control, manufacturing control, engineering, and a variety of other business processes. Such data storage systems may have a single host architecture or a multi-host architecture. Each host is a computer with processing and memory resources. Network-Attached Storage (NAS) and Direct Attached Storage (DAS) are examples of single host architectures in which an individual storage server maintains exclusive control over its processing and memory resources. Multiple single-host storage systems may be used together to increase storage capacity and input-output (IO) capabilities, but the individual hosts do not share processing and memory resources in a highly integrated manner. In contrast, multi-host storage systems such as Storage Area Networks (SANs) and storage arrays include multiple highly integrated hosts that share processing and memory resources.

### SUMMARY

A method in accordance with some implementations comprises: receiving a signal to update firmware of a second network interface card in a multi-host storage system in which a first host and a second host are memory-mirrored pairs, a first network interface card is mounted to the first host and connected to an inter-nodal fabric, the second network interface card is mounted to the second host and connected to the inter-nodal fabric, the first host is connected to the second network interface card by a first bus, and the second host is connected to the first network interface card by a second bus; invoking multi-host failover to the first network interface card in response to the signal, causing the first host and the second host to use the first network interface card and cease using the second network interface card; updating the firmware of the second network interface card; and configuring the first host and the second host to use the second network interface card.

An apparatus in accordance with some implementations comprises: a first host; a first network interface card mounted to the first host; a second host; a second network interface card mounted the second host; a first bus connecting the first host with the second network interface card; a second bus connecting the second host with the first network interface card; and at least one controller configured to: receive a signal to update firmware of the second network interface card; invoke multi-host failover to the first network interface card in response to the signal, causing the first host and the second host to use the first network interface card and cease using the second network interface card; update the firmware of the second network interface card; and configure the first host and the second host to use the second network interface card.

A non-transitory computer-readable storage medium in accordance with some implementations stores instructions that are executed by a storage system to perform a method comprising: receiving a signal to update firmware of a second network interface card in a multi-host storage system in which a first host and a second host are memory-mirrored pairs, a first network interface card is mounted to the first host and connected to an inter-nodal fabric, the second network interface card is mounted to the second host and connected to the inter-nodal fabric, the first host is connected to the second network interface card by a first bus, and the second host is connected to the first network interface card by a second bus; invoking multi-host failover to the first network interface card in response to the signal, causing the first host and the second host to use the first network interface card and cease using the second network interface card; updating the firmware of the second network interface card; and configuring the first host and the second host to use the second network interface card.

This summary is not intended to limit the scope of the claims or the disclosure. Other aspects, features, and implementations will become apparent in view of the detailed description and figures. Moreover, all the examples, aspects, implementations, and features can be combined in any technically possible way.

### BRIEF DESCRIPTION OF THE FIGURES

FIG. 1 illustrates a multi-host storage system with non-disruptive firmware update controllers.

FIG. 2 illustrates a specific example of the communication links of the storage system of FIG. 1.

FIG. 3 illustrates aspects of the multi-host environment in greater detail.

FIG. 4 illustrates drivers and resources affected by a NIC firmware update.

FIG. 5 illustrates a method for performing a non-disruptive NIC firmware update in a multi-host environment.

### DETAILED DESCRIPTION

The terminology used in this disclosure is intended to be interpreted broadly within the limits of subject matter eligibility. The terms “disk,” “drive,” and “disk drive” are used interchangeably to refer to non-volatile storage media and are not intended to refer to any specific type of non-volatile storage media. The terms “logical” and “virtual” are used to refer to features that are abstractions of other features, for example, and without limitation, abstractions of tangible features. The term “physical” is used to refer to tangible features that possibly include, but are not limited to, electronic hardware. For example, multiple virtual computers could operate simultaneously on one physical computer. The term “logic” is used to refer to special purpose physical circuit elements, firmware, software, computer instructions that are stored on a non-transitory computer-readable medium and implemented by multi-purpose tangible processors, and any combinations thereof. Aspects of the inventive concepts are described as being implemented in a data storage system that includes host servers and a storage array. Such implementations should not be viewed as limiting. Those of ordinary skill in the art will recognize that there are a wide variety of implementations of inventive concepts in view of the teachings of the present disclosure.

Some aspects, features, and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory computer-readable medium. Furthermore, it will be understood by those of ordinary skill in the art that the computer-executable instructions may be executed on a variety of tangible processor devices, i.e., physical hardware. For practical reasons, not every step, device, and component that may be part of a computer or data storage system is described herein. Those of ordinary skill in the art will recognize such steps, devices, and components in view of the teachings of the present disclosure and the knowledge generally available to those of ordinary skill in the art. The corresponding machines and processes are therefore enabled and within the scope of the disclosure.

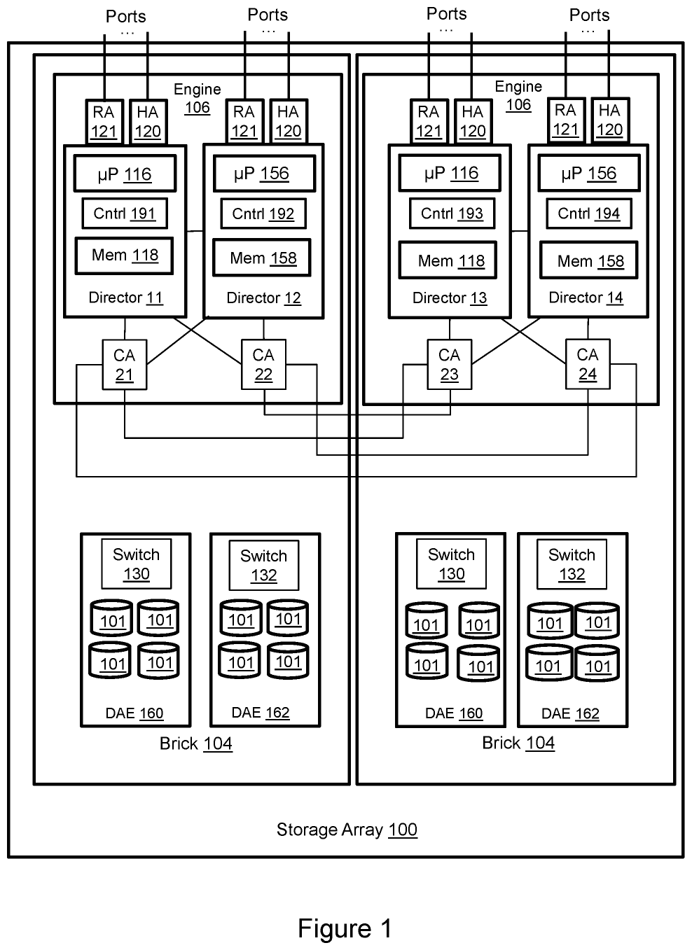

FIG. 1 illustrates a multi-host storage system with non-disruptive firmware update controllers 191, 192, 193, 194. The illustrated multi-host storage system is a storage array 100, but the concepts disclosed herein are not limited to storage arrays. The storage array 100 includes one or more bricks 104. Each brick 104 includes an engine 106 and one or more disk array enclosures (DAEs) 160, 162. In the illustrated example there are only two engines, but the storage array could include a greater number of engines or a single engine. Each engine 106 includes two interconnected specialized computers referred to as “hosts,” “compute nodes,” or “storage directors” 11, 12, 13, 14. Within each engine, the storage directors are arranged as a memory-mirrored pair with failover capability so IO processing can continue when one of the storage directors fails. Each storage director may be implemented on a separate printed circuit board (“motherboard” or “blade”) that is populated with hardware resources including at least one multi-core processor 116, 156 and local memory 118, 158. The multi-core processor may include central processing units (CPUs), graphics processing units (GPUs), or both installed via multiple sockets. The local memory 118, 158, which is onboard memory (not CPU cache), may include volatile media such as dynamic random-access memory (DRAM), non-volatile memory (NVM) such as storage class memory (SCM), or both. Each storage director includes one or more host adapters (HAs) 120 for communicating with external host servers. Each host adapter is a network interface card (NIC) that has multiple ports for communicating with external host servers. The host servers may be referred to as “initiators” that send IO commands to the storage array as a “target.” Each host server may be connected to the storage array via multiple ports corresponding to multiple paths that enable load balancing and failover. The host adapter resources include processors, volatile memory, and components such as IO chips that monitor link errors and IO failures such as missing frames, timeouts, and received aborts. Each storage director also includes a remote adapter (RA) 121, which is a NIC with ports for communicating with other storage systems, e.g., other storage arrays. Each storage director also includes one or more multi-host capable channel adapters (CAs) 21, 22, 23, 24, which are NICs for communicating with storage directors of other engines. Each CA, HA, and RA is logically part of a storage director but physically on a different PCB. The managed drives 101 include non-volatile storage media that may be of any type, e.g., solid-state drives (SSDs) based on EEPROM technology such as NAND and NOR flash memory and hard disk drives (HDDs) with spinning disk magnetic storage media. Within each brick, the storage directors are connected to DAEs 160, 162 via switches 130, 132.

The non-disruptive firmware update controllers 191, 192, 193, 194 may include one or more of firmware, specialized hardware, and software, e.g., software residing in memory and executed by the processors. As will be described below, the firmware update controllers utilize the multi-host architecture to update the firmware of the NICs, one at a time, without disrupting IO processing by the storage directors.

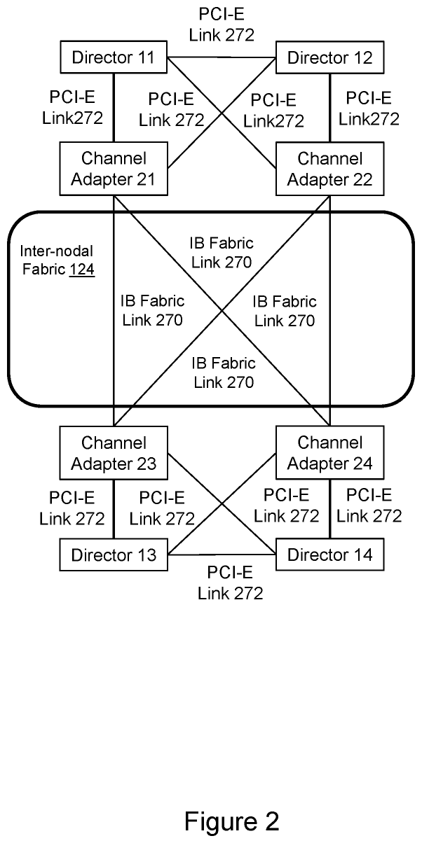

FIG. 2 illustrates a specific example of the communication links of the storage array of FIG. 1. An inter-nodal fabric 124 is implemented by multiple InfiniBand (IB) links 270 between channel adapter endpoints CA21-CA23, CA21-CA24, CA22-CA23, and CA22-CA24. InfiniBand is a fabric architecture that transports messages between end nodes. The channel adapters are multi-host capable and the links between each multi-socket host and its associated channel adapter, e.g., between storage director 11 and channel adapter 21, are Peripheral Component Interconnect Express (PCI-E) links 272 (or ultra path interconnect (UPI), QuickPath Interconnect (QPI), or HyperTransport, for example, and without limitation). PCI-E is a bus architecture via which packets are transported between endpoints. The channel adapters from different storage director motherboards associated with a single engine are also connected to the other storage director of the engine via different PCI-E links 272, e.g., channel adapter 21 is connected to storage director 13 via a PCI-E bus.

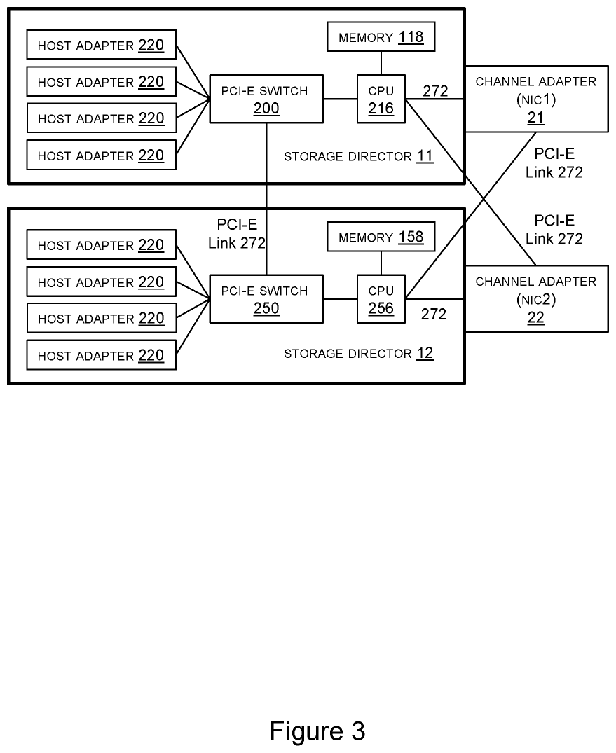

FIG. 3 illustrates aspects of the multi-host environment in greater detail. The storage directors 11, 12 include CPU root complexes 216, 256, respectively, each with multiple sockets on a single motherboard. Each socket includes a package with one or more CPU dies mounted therein. The sockets are interconnected with each other and local memory 118, 158 via a PCI-E bus (or ultra path interconnect (UPI), QuickPath Interconnect (QPI), or HyperTransport, for example, and without limitation). The CPU root complexes 216, 256 are interconnected with host adapters 220 vie PCI-E switches 200, 250 and PCI-E links. Within each engine, the PCI-E switches are interconnected via PCI-E links 272. Each CPU root complex is connected with its local (NIC mounted to motherboard) channel adapter and also with the channel adapter of the storage director with which it is paired in the engine via PCI-E links 272. When channel adapter 22 (which may be referred to as NIC2) is undergoing a firmware update, storage director 12 uses channel adapter 21 (which may be referred to as NIC1) to maintain IO processing operations by invoking failover.

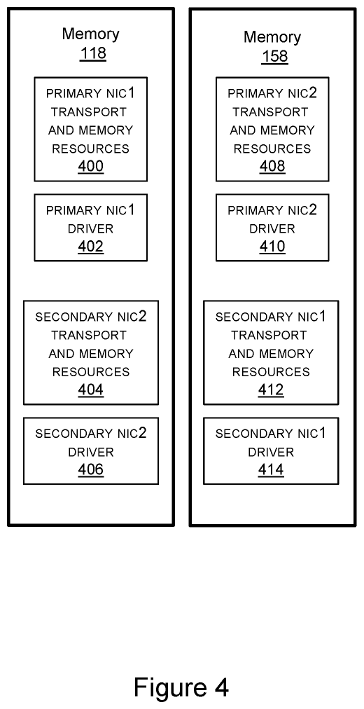

FIG. 4 illustrates drivers and resources potentially affected by a NIC firmware update. Primary NIC1 transport and memory resources 400, a primary NIC1 driver 402, secondary NIC2 transport and memory resources 404, and secondary NIC2 driver 406 are in memory 118. Primary NIC2 transport and memory resources 408, a primary NIC2 driver 410, secondary NIC1 transport and memory resources 412, and secondary NIC1 driver 414 are in memory 158. NIC1 drivers and resources are affected by updating the NIC1 firmware. NIC2 drivers and resources are affected by updating the NIC2 firmware.

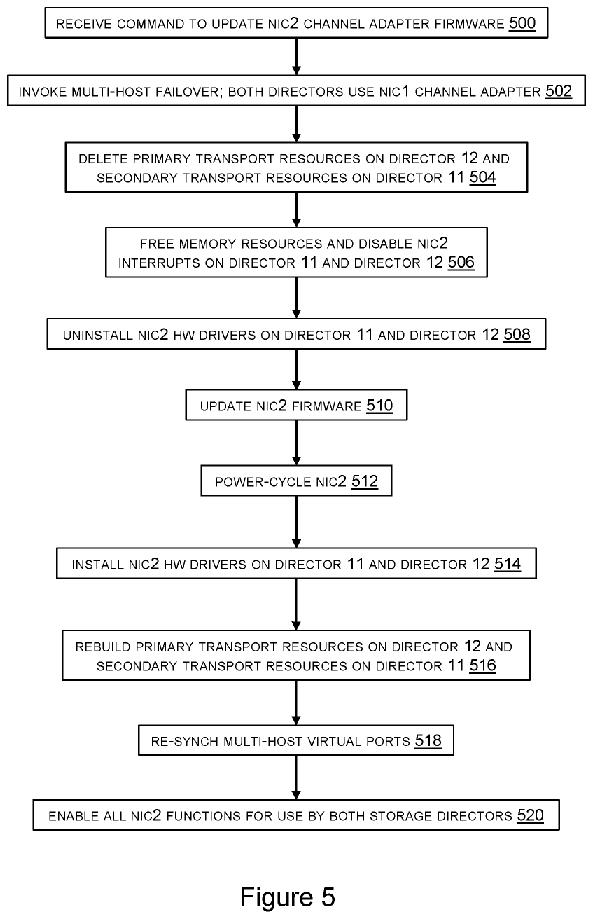

FIG. 5 illustrates a method for performing a non-disruptive NIC firmware update in a multi-host environment. Updating the NIC2 firmware is used for context but the same procedure can be applied for updating the NIC1 firmware by interchanging references to NIC1 and NIC2 in the description. Step 500 is receiving a command to update the NIC2 firmware. In response, step 502 is invoking multi-host failover, which causes both storage directors to use NIC1 and cease using NIC2. Step 504 is deleting the primary transport resources on storage director 12 and the secondary transport resources on storage director 11. In the context of InfiniBand, the transport resources may include Queue Pairs (QPs), Event Queues (EQs), and Completion Queues (CQs). Step 506 is freeing memory resources and disabling NIC2 interrupts on storage director 11 and storage director 12. Step 508 is uninstalling NIC2 hardware drivers on storage director 11 and storage director 12. The NIC2 firmware is updated in step 510. This may include loading a new image, performing an image integrity check, burning the new firmware into an alternative flash partition, and verifying the new firmware image. NIC2 is power-cycled in step 512 to make the new firmware active. Step 514 is installing NIC2 hardware drivers on storage director 11 and storage director 12. Step 516 is rebuilding the primary transport resources on storage director 12 and the secondary transport resources on storage director 11. Step 518 is resynchronizing the multi-host virtual ports of the buses to support multi-hosting. In step 520, all NIC2 functions are enabled for use by both storage directors. Storage director 11 host is configured to use NIC1 and NIC2. Storage director 12 is also configured to use NIC2 and NIC1.

Specific examples have been presented to provide context and convey inventive concepts. The specific examples are not to be considered as limiting. A wide variety of modifications may be made without departing from the scope of the inventive concepts described herein. Moreover, the features, aspects, and implementations described herein may be combined in any technically possible way. Accordingly, modifications and combinations are within the scope of the following claims.

What is claimed is:

1. A method, comprising:
receiving a signal to update firmware of a second network interface card in a multi-host storage system in which a first host and a second host are memory-mirrored pairs, a first network interface card is mounted to the first host and connected to an inter-nodal fabric, the second network interface card is mounted to the second host and connected to the inter-nodal fabric, the first host is connected to the second network interface card by a first bus, and the second host is connected to the first network interface card by a second bus;
invoking multi-host failover to the first network interface card in response to the signal, causing the first host and the second host to use the first network interface card and cease using the second network interface card;
updating the firmware of the second network interface card; and
configuring the first host and the second host to use the second network interface card.

2. The method of claim 1 further comprising deleting primary transport resources on the second host and deleting secondary transport resources on the first host.

3. The method of claim 2 further comprising freeing memory resources and disabling second network interface card interrupts on the first host and the second host.

4. The method of claim 3 further comprising uninstalling second network interface card drivers on the first host and the second host.

5. The method of claim 4 further comprising installing second network interface card drivers on the first host and the second host.

6. The method of claim 5 further comprising rebuilding primary transport resources on the second host and secondary transport resources on the first host.

7. The method of claim 6 further comprising resynchronizing multi-host virtual ports of the first and second buses to support multi-hosting.

8. An apparatus comprising:
a first host;
a first network interface card mounted to the first host;
a second host;
a second network interface card mounted the second host;
a first bus connecting the first host with the second network interface card;
a second bus connecting the second host with the first network interface card; and
at least one controller configured to:
receive a signal to update firmware of the second network interface card;
invoke multi-host failover to the first network interface card in response to the signal, causing the first host and the second host to use the first network interface card and cease using the second network interface card;
update the firmware of the second network interface card; and
configure the first host and the second host to use the second network interface card.

9. The apparatus of claim 8 further comprising the controller being configured to delete primary transport resources on the second host and delete secondary transport resources on the first host.

10. The apparatus of claim 9 further comprising the controller being configured to free memory resources and disable second network interface card interrupts on the first host and the second host.

11. The apparatus of claim 10 further comprising the controller being configured to uninstall second network interface card drivers on the first host and the second host.

12. The apparatus of claim 11 further comprising the controller being configured to install second network interface card drivers on the first host and the second host.

13. The apparatus of claim 12 further comprising the controller being configured to rebuild primary transport resources on the second host and secondary transport resources on the first host.

14. The apparatus of claim 13 further comprising the controller being configured to resynchronize multi-host virtual ports of the first and second buses to support multi-hosting.

15. A non-transitory computer-readable storage medium storing instructions that are executed by a storage system to perform a method comprising:
receiving a signal to update firmware of a second network interface card in a multi-host storage system in which a first host and a second host are memory-mirrored pairs, a first network interface card is mounted to the first host and connected to an inter-nodal fabric, the second network interface card is mounted to the second host and connected to the inter-nodal fabric, the first host is connected to the second network interface card by a first bus, and the second host is connected to the first network interface card by a second bus;
invoking multi-host failover to the first network interface card in response to the signal, causing the first host and the second host to use the first network interface card and cease using the second network interface card;
updating the firmware of the second network interface card; and
configuring the first host and the second host to use the second network interface card.

16. The non-transitory computer-readable storage medium of claim 15 in which the method further comprises deleting primary transport resources on the second host and deleting secondary transport resources on the first host.

17. The non-transitory computer-readable storage medium of claim 16 in which the method further comprises freeing memory resources and disabling second network interface card interrupts on the first host and the second host.

18. The non-transitory computer-readable storage medium of claim 17 in which the method further comprises uninstalling second network interface card drivers on the first host and the second host.

19. The non-transitory computer-readable storage medium of claim 18 in which the method further comprises installing second network interface card drivers on the first host and the second host.

20. The non-transitory computer-readable storage medium of claim 19 in which the method further comprises rebuilding primary transport resources on the second host and secondary transport resources on the first host and resynchronizing multi-host virtual ports of the first and second buses to support multi-hosting.
